(19) United States
(12) Patent Application Publication
(10) Pub. No.: US 2019/0308845 A1
(43) Pub. Date: Oct. 10, 2019

(54) ELEVATOR SYSTEM WITH A BUS BAR AND A CURRENT COLLECTOR

(71) Applicants: thyssenkrupp Elevator AG, Essen (DE); thyssenkrupp AG, Essen (DE)

(72) Inventors: Daniel BAUER, Durlangen (DE); Matthias GLÜCK, Hochdorf (DE); Ruslan BONDARENKO, Weilheim an der Teck (DE); Markan LOVRIC, Stuttgart (DE)

(73) Assignees: thyssenkrupp Elevator AG, Essen (DE); thyssenkrupp AG, Essen (DE)

(21) Appl. No.: 16/465,633

(22) PCT Filed: Nov. 23, 2017
(86) PCT No.: PCT/EP2017/080203

§ 371 Date: May 31, 2019

(30) Foreign Application Priority Data
Dec. 1, 2016 (DE) 10 2016 223 913.9

(51) Int. Cl. B66B 1/30; B66B 11/04; B66B 5/02; B66B 11/00; H01R 41/00

(52) U.S. Cl. CPC B66B 1/30; B66B 11/0407; H01R 41/00; B66B 5/02; B66B 11/005; B66B 11/04

(57) ABSTRACT

An elevator system having a car which can be moved along an elevator shaft in a direction of travel. The elevator shaft includes a busbar that extends in the direction of the direction of travel. The car comprises a current collector that can be moved between a first position and a second position along a compression direction. In the first position, the current collector is in engagement with the busbar such that there is an electrical connection between the busbar and the current collector. In the second position, the current collector is disengaged from the busbar, such that the electrical connection between the busbar and the current collector is separated.

The invention relates to an elevator system having a car, which can be moved in a direction of travel along the elevator shaft. Elevator systems serve to move passengers between different stories of a building. To this end, a car is moved between the stories within an elevator shaft. Conventionally, for this purpose, the car is connected to a counterweight by means of a suspension rope, wherein the rope engages with a motorized drive pulley. Conversely, alternative elevator systems have now dispensed with counterweights, and are driven by linear motors, which are integrated in the rails and the cars.

Additionally, a typical car is connected by means of a suspension cable to the shaft wall of the elevator shaft. Power is supplied to the car via this suspension cable, for example for the operation of interior lighting in the car and the control elements in the interior of the car. In more recent elevator systems, however, the car travels not only upwards and downwards, but also between a plurality of vertically oriented elevator shafts. An elevator system of this type is known, for example, from JP H06-48672. Consequently, in systems of this type, a connection of the car to the shaft wall by means of a suspension cable is only possible with the greatest of difficulty.

Independently of this, elevator systems have occasionally been proposed in which power is supplied to the car by means of a permanent sliding contact between a current collector on the car and a busbar in the elevator shaft. A system of this type is disclosed, for example, in U.S. Pat. No. 1,859,483. In this case, however, the electric power supply is provided for the operation of a drive motor, which is arranged on the car. Moreover, a permanent sliding contact has the disadvantage of sustaining a high degree of wear, and consequently requires frequent replacement. A permanent sliding contact additionally results in the continuous generation of noise during the travel of the elevator, thereby impairing traveling comfort.

It is therefore an object of the present invention to further develop an elevator system such that comfort of travel in the elevator is ensured, with the simultaneous supply of power to the car, without the use of suspension cables.

This object is fulfilled by an elevator system having a car which can be moved along an elevator shaft in a direction of travel, wherein the elevator shaft comprises a busbar, which extends along the direction of travel, and wherein the car comprises a current collector. The current collector can be moved between a first position and a second position along a compression direction. The current collector, in the first position, is in engagement with the busbar, such that there is an electrical connection between the busbar and the current collector. The current collector, in the second position, is disengaged from the busbar, such that the electrical connection between the busbar and the current collector is separated. In the first position, the car is thus connected to an external power supply, such that the electrical system of the car, including the electrical components such as, for example, the interior lighting, control elements or the door drive unit, are supplied with power. In the second position, there is no mechanical contact between the current collector and the busbar. This has the advantage that the current collector does not slide along the busbar during the travel of the car. Noise production and the generation of vibrations are consequently prevented. At the same time, the current collector sustains limited wear, as there is no permanent sliding contact during travel.

In an embodiment according to a further development of the invention, the car comprises an energy store, in particular a lithium-ion accumulator. For such time as the current collector is in the second position, and the electrical connection between the busbar and the current collector is interrupted, the supply of power to the electrical components of the car is assumed by the energy store. For such time as the current collector is in the first position, and an electrical connection between the busbar and the current collector is in place, the energy store is charged via the busbar by means of an external power supply. At the same time, the electrical components of the car can be supplied directly by the external power supply. Alternatively, the supply of power to the electrical components of the car can also be assumed by the energy store in the first position. This embodiment has advantage that a continuous supply of power to the electrical components of the car is permitted, regardless of whether an electrical connection is present between the current collector and the busbar.

In one variant of embodiment of the invention, the elevator system comprises a control system which is configured, in the event of an undershoot of a limiting speed, to initiate the conveyance of the current collector into the first position. The control system is further configured, in the event of an overshoot of the limiting speed, to initiate the conveyance of the current collector into the second position. This has the advantage that the current collector is only in the first position for such time as the speed of the car lies below the limiting speed. Accordingly, mechanical contact between the current collector and the busbar is only present for such time as the speed of the car lies below the limiting speed.

The limiting speed can, for example, be 0 m/s. This means that the current collector is only in engagement with the busbar if the car has come to rest. In this manner, wear of the current collector and the busbar, and the generation of noise, can be substantially prevented.

However, the limiting speed can also lie, for example, within a range of 0.1 m/s to 0.5 m/s, in particular from 0.2 m/s to 0.4 m/s, and can in particular be 0.3 m/s.

A limiting speed greater than zero signifies that, during a braking process associated with the transition to a stopping position, an electrical connection is established between the busbar and the current collector, even before the car has finally come to rest. Correspondingly, the electrical connection between the busbar and the current collector remains in place during the acceleration process associated with a departure from the stopping position. The higher the limiting speed, the earlier the electrical connection is established, and the longer the electrical connection remains in place upon the start of travel. A higher limiting speed thus results in a longer time period during which an electrical connection is present between the busbar and the current collector. A longer time period has the advantage that a longer charging time of the energy store in the car is permitted. Moreover, in particular during the arrival at, or departure from a stopping position, specific electrical components of the car are required. This applies in particular to the drive unit of the cabin door. Typically, the opening process of the cabin door is initiated even before the car has come to rest in its final stopping position. Correspondingly, the closing process of the cabin door is typically not fully complete as the car commences the departure process from the stopping position. A longer time period thus has the advantage that the electrical components of the car which are required during the arrival at, and departure from a stopping position, can continue to be substantially operated by means of the external power supply, and do not need to be supplied by the energy store. As a result of both these effects, a smaller, and thus more cost-effective energy store can be employed in the car.

Additionally, a lower limiting speed provides the advantage that the wear of the current collector and the busbar is reduced. For such time as the car is moving below the limiting speed, a sliding contact is in place between the current collector and the busbar. This sliding contact leads to wear of the current collector and the busbar. The lower the limiting speed, the more limited the wear of the current collector and the busbar, and the lower the generation of noise associated with the sliding contact.

It has been demonstrated that an effective compromise between these two effects delivers a limiting speed which lies within the range of 0.1 m/s to 0.5 m/s, in particular within the range of 0.2 m/s to 0.4 m/s, and in particular lies at a value of 0.3 m/s. Limiting speeds of this order permit an adequate charging time for the energy store in the car, while simultaneously maintaining the wear of the current collector within acceptable limits.

In one variant of embodiment of the invention, the elevator system comprises a control system which is configured, in the event of an emergency stop, to convey the current collector to the first position. This has the advantage that the supply of power to the car is maintained during repair and/or evacuation.

In an embodiment according to a further development of the invention, the elevator system comprises a drive unit for the propulsion of the car, wherein the drive unit is operable, regardless of whether the electrical connection is present between the busbar and the current collector. This has the advantage that it is not necessary for the drive energy to be transmitted between the busbar and the current collector. The busbar and the current collector can therefore be configured to have smaller dimensions.

In one form of embodiment of the invention, the car comprises a first pressure accumulator, which compresses the current collector into the first position. The car further comprises a retention device, which retains the current collector in the second position. The retention device is configured, upon the release of the retention device, to permit the compression of the current collector by the first pressure accumulator into the first position. The current collector is thus retained by the retention device, against the force of the first pressure accumulator, in the second position. When the retention device is released, the current collector, by means of the force of the first pressure accumulator, is moved to the first position. This has the advantage that the current collector can be moved from the second position to the first position, even if the electrical system of the car is not supplied with power. Consequently, even if the energy store of the car is empty, the current collector can be moved to the first position by means of the exclusively mechanically stored energy in the pressure accumulator, such that an electrical connection with the busbar, and thus with the external power supply, can be constituted. In particular, one or more helical springs can be employed as a pressure accumulator.

In a further development of this form of embodiment, the car comprises a reset device, in order to move the current collector from the first position to the second position. The reset device thus moves the current collector, against the force of the first pressure accumulator, into the second position. As a result, further mechanical energy is stored in the pressure accumulator, in order to permit the execution of a further release process, as described above. The reset device in particular comprises a pneumatic cylinder and a compressor. A negative pressure is applied to the pneumatic cylinder by means of the compressor, such that the piston of the pneumatic cylinder, against the force of the first pressure accumulator, moves away from the busbar, along the compression direction. Since the piston of the pneumatic cylinder is mechanically coupled to the current collector, the current collector likewise moves away from the busbar in response, into the second position. For such time as the negative pressure is maintained, the piston of the pneumatic cylinder remains in this position. The pneumatic system further comprises a ventilation valve, which functions as a retention device. By opening the ventilation valve, i.e. releasing the retention device, the negative pressure is lost such that the piston of the pneumatic cylinder is moved towards the busbar by the force of the first pressure accumulator. The use of pneumatic cylinders provides the advantage that, conversely to electric motors, a higher working speed can be achieved. Additionally, the reset device can be configured to be of exceptionally lightweight design. This is particularly important for the present use in a car which is not coupled to a counterweight.

Alternatively, an electric motor or a spindle drive can also be employed as a reset device.

The retention device can also comprise, for example, an electromagnet which retains the current collector in the second position, against the force of the first pressure accumulator. In this case, the release of the retention device would result in the de-energization of the electromagnet.

In a further form of embodiment of the elevator system according to the invention, the busbar comprises a plurality of recesses, which extend in the direction of travel. Each of the recesses comprises, in its interior, a contact region, to which the voltage which is to be transmitted is applied. This variant provides the advantage that the live parts are arranged within recesses in the busbar. Consequently, there is no risk of the service personnel inadvertently coming into contact with the live parts during the conduct of maintenance operations in the elevator shaft. The accident risk is significantly reduced accordingly. The contact regions are in particular configured in the form of copper strip conductors, which exhibit particularly good conductivity.

This variant of embodiment is in particular further developed in that the current collector comprises a plurality of collector contacts, wherein, in the first position, one collector contact respectively engages in one recess of the busbar, such that the collector contacts make contact with the contact regions in the interior of the recesses. In this manner, a reliable electrical connection is permitted between the busbar and the current collector in the first position, even if the contact regions of the busbar are arranged in the interior of recesses.

In order to ensure the secure engagement of the collector contacts in the recesses of the busbar, the busbar in particular comprises lead-in chamfers, which extend along the recesses. These are oriented such that, for each recess, in cross section, an insertion funnel is constituted. The insertion funnel ensures the secure guidance of the collector contacts into the recesses and onto the contact regions. The lead-in chamfers can be configured as separate components, or integrally formed in the rail body of the busbar.

In another further development of the elevator system according to the invention, the current collector comprises a socket and a plurality of collector contacts. Each of the collector contacts is moveable vis-à-vis the socket, along the compression direction. The current collector further comprises a plurality of second pressure accumulators, each of which is assigned to a collector contact. The second pressure accumulators compress the associated collector contact vis-à-vis the socket along the compression direction towards the busbar. The second pressure accumulators are in particular configured as helical springs, which are arranged between the collector contacts and the socket. By means of this further development, any uneven wear of the collector contacts is compensated. As a result of uneven wear, the lengths of the collector contacts will differ from one another, after a certain duration of operation. In consequence, it is possible that, in the first position, all the collector contacts will no longer make contact with their associated contact regions. Accordingly, not all the requisite electrical connections would be provided. In order to prevent this, the second pressure accumulators are arranged between the socket and the collector contacts. The pressure accumulators ensure that, in such a case, the more heavily worn, and thus shorter collector contacts are disengaged further from the socket, in order to offset the difference in length. Accordingly, in such a case, it is thus further ensured that all the collector contacts make contact with their associated contact regions, for such time as the current collector is in the first position.

In a further form of embodiment of the elevator system according to the invention, the current collector comprises a socket and a plurality of collector contacts, wherein each of the collector contacts is pivotably arranged vis-à-vis the socket about a swivel axis. The swivel axis is typically parallel to the direction of travel of the car and parallel to the main direction of extension of the busbar. This has the advantage that the collector contacts, even in the event of a certain lateral offset between the busbar and the current collector, are reliably guided, upon the insertion thereof into the recesses, towards the contact regions. Upon the switchover from the second position to the first position, i.e. upon the introduction of the collector contacts into the recesses, the collector contacts, in the event of a lateral offset, would initially engage with the lead-in chamfers. In the absence of a swivel capability about the swivel axis, the insertion process of the collector contacts would terminate at this point or, in the event of a force of sufficient magnitude, the collector contacts would buckle. However, as the collector contacts are pivotable, the lead-in chamfers, as the insertion movement proceeds, now result in a pivoting of the collector contacts about the respective swivel axis, until the tips of the collector contacts are able to engage in the recesses. Typically, the lateral offset between the busbar and the current collector is attributable to an error in the fitting of the busbar or an error in the fitting of the guide pulleys of the car. A further cause of a lateral offset may be uneven wear of guide pulleys of the car which, after a certain duration of operation, also results in a lateral offset. Since the guide pulleys are unevenly worn, the car is no longer accurately centered, but is positioned with a lateral offset in relation to its original desired position. Accordingly, the car is also laterally offset in relation to the busbar which is rigidly attached to the elevator wall. The swivel capability of the collector contacts thus permits a high degree of tolerance vis-à-vis any lateral offset.

In a further development of this variant of embodiment, the plurality of collector contacts are mutually bonded by means of coupling elements, such that the plurality of collector contacts are only pivotable in combination. On account of the above-mentioned causes of lateral offset, an overall lateral offset is still present between the busbar and the current collector. Each collector contact therefore has the same lateral offset in relation to its associated recess in the busbar. Consequently, all the collector contacts are required to execute the same pivoting motion upon the engagement thereof in the associated recess. It is therefore advantageous that the collector contacts should be coupled, such that they are only pivotable in combination.

In particular, this variant of embodiment is further developed in that the current collector comprises a third pressure accumulator. The third pressure accumulator is configured to compress the plurality of collector contacts back to a resting position, following pivoting thereof. If, on account of the lateral offset in the course of the approach movement, a pivoting of the collector contacts is required, the action of the third pressure accumulator is such that the collector contacts, following pull-out (i.e. once the current collector has been restored to the second position), are returned to their resting position. The third pressure accumulator is therefore coupled to the collector contacts, such that it counteracts a pivoting movement of the collector contacts from a resting position. For example, the third pressure accumulator can comprise helical springs which, in the event of a pivoting movement of the collector contacts, are compressed or tensioned. In the resting position, the collector contacts are typically oriented in parallel with the compression direction.

In an alternative form of embodiment of the invention, at least one stationary component is arranged in the elevator shaft, which component is supplied with power via the busbar. This has the advantage that additional cabling along the elevator shaft can be substantially omitted, because the busbar is simultaneously employed for the supply of power to stationary components. In particular, to this end, the stationary component is electrically connected to the busbar by means of an outfeed contact. This outfeed contact is configured to an identical design to an infeed contact, by means of which the busbar is connected to an external power supply. The identical design of the infeed contacts and outfeed contacts permits the number of different components to be reduced.

In addition to the stipulated elevator system, the invention further relates to a method for operating such an elevator system, wherein the current collector is moved from the first position to the second position, once a speed of the car exceeds a limiting speed. Correspondingly, the invention also relates to a method for operating such an elevator system, wherein the current collector is moved from the second position to the first position, once a speed of the car undershoots the limiting speed. These methods have the advantages which were described above with relation to the limiting speed.

The invention further relates to a method for operating an above-described elevator system, wherein the current collector, in the event of an emergency stop, is moved to the first position. This provides the advantage that the supply of power to the car is maintained during repair and/or evacuation.

The invention is described in greater detail with reference to the figures, in which:

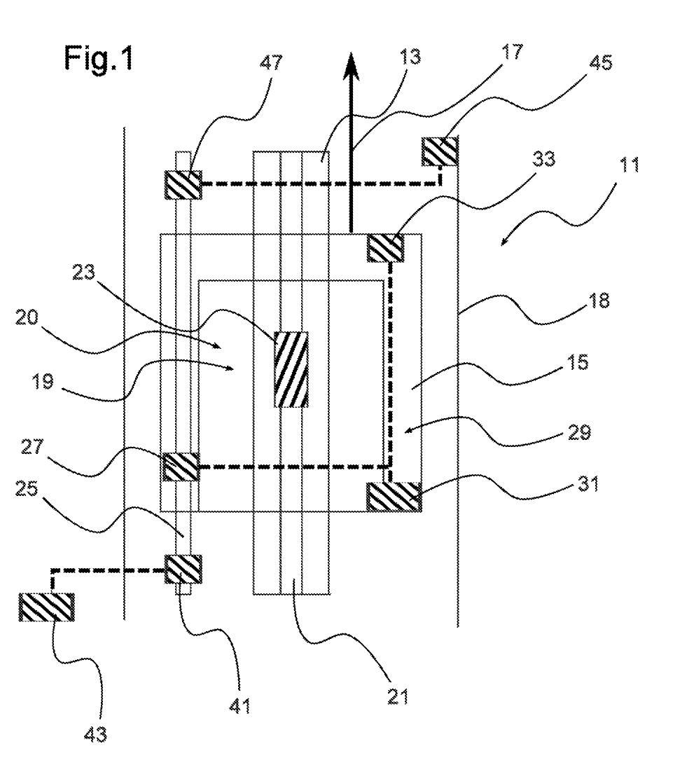

FIG. 1 shows a schematic representation of a car in an elevator shaft with a busbar;

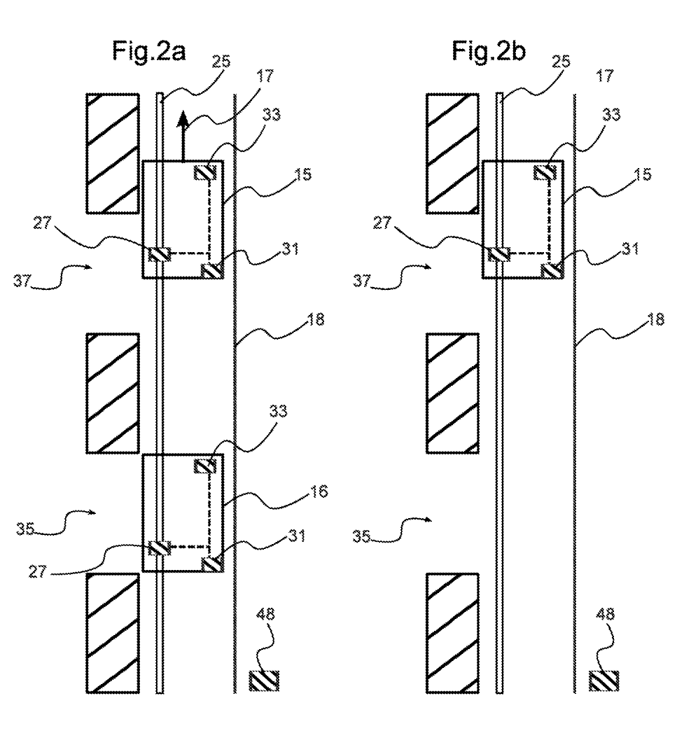

FIG. 2a and FIG. 2b show schematic representations of the elevator system;

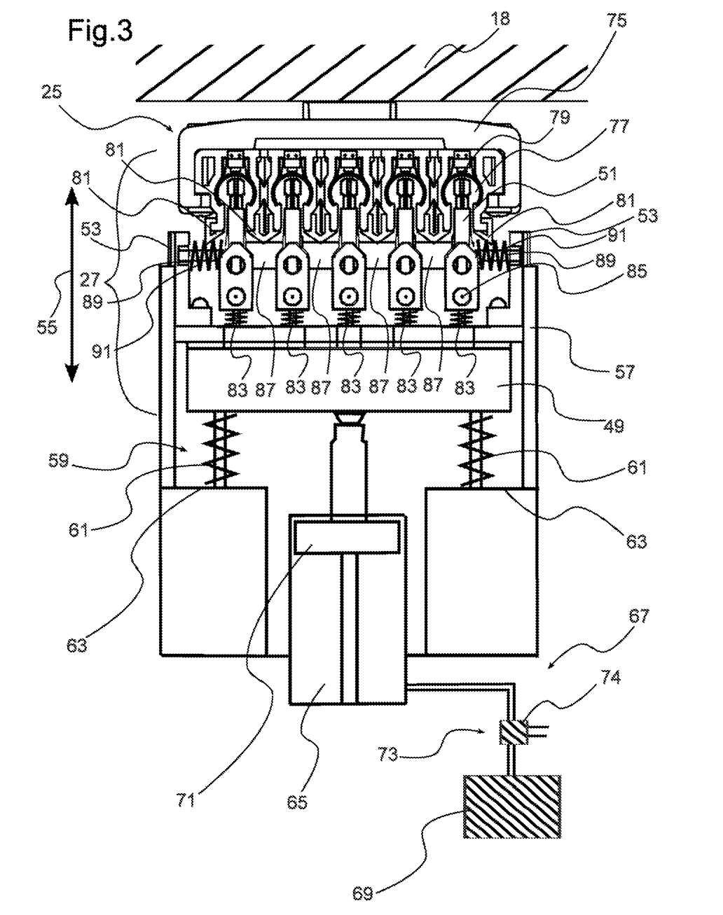

FIG. 3 shows a cross section through the busbar and the current collector, wherein the current collector is located in the first position;

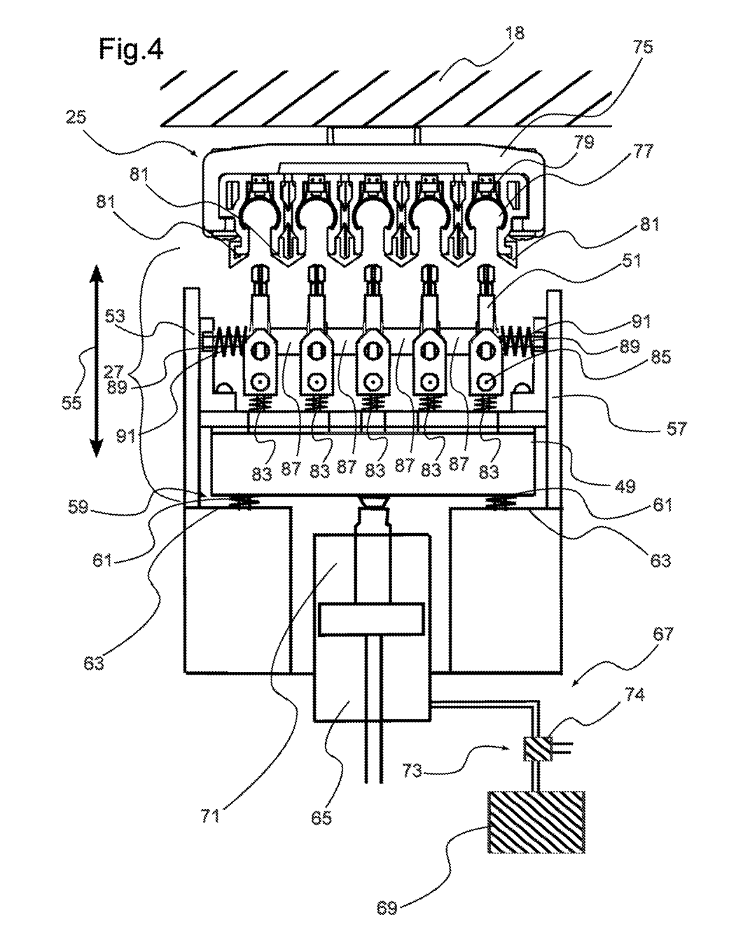

FIG. 4 shows a cross section through the busbar and the current collector, wherein the current collector is located in the second position.

FIG. 1 shows a schematic representation of an elevator system 11. The elevator system 11 comprises a guide rail 13 and a car 15. The car 15 is moveable along the guide rail 13 in a direction of travel 17 within the elevator shaft 18. The elevator system 11 is configured in a “rucksack” configuration. The guide rail 13 is thus arranged on only one side of the car 15.

The elevator shaft 18 comprises a busbar 25, which extends in the direction of the direction of travel 17. The busbar 25 is thus parallel to the guide rail 13. The car 15 comprises a current collector 27, in order to transmit electrical energy from the busbar 25 to the moveable car 15. The current collector 27 can be moved between a first position and a second position. In the first position, the current collector 27 is in engagement with the busbar 25, such that an electrical connection is present between the busbar 25 and the current collector 27. In the second position, the current collector 27 is disengaged from the busbar 25, such that the electrical connection between the busbar 25 and the current collector 27 is interrupted. Potential forms of construction of the current collector 25 and the busbar 27 are described with reference to the following figures. The car 15 further comprises an electrical system 29, by means of which electrical energy collected from the busbar 25 is distributed in the interior of the car 15. An element of this electrical system 29 is an energy store 31. The energy store is configured in particular as a lithium-ion accumulator. The energy store 31 is charged via the busbar 25 while the current collector 27 is in the first position, such that an electrical connection between the busbar 25 and the current collector 27 is present. For such time as the current collector 27 is disengaged from the busbar 25, i.e. is located in the second position, the supply of power to electrical components 33 of the car 15 is delivered by the energy store 31. The electrical components 33 can include, for example, the interior lighting of the car 15 or the control elements in the interior of the car 15. The busbar 25 is connected to an external power supply 43 via an infeed contact 41.

The elevator system 11 comprises a drive unit 19 for the propulsion of the car 15. The drive unit is configured in the form of a linear motor 20. The linear motor 20 comprises a stationary component 21, which extends along the guide rails 13, and a mobile component 23, which is connected to the car 15. The mobile component 23 is a passive component, which is not reliant upon an electric power supply, for example a permanent magnet. The drive unit 19 is therefore operable, regardless of whether the electrical connection between the busbar 25 and the current collector 27 is present.

In the elevator shaft 18, a stationary component 45 is additionally arranged, which is supplied with power via the busbar 25. To this end, the stationary component 45 is electrically connected to the busbar 25 via an outfeed contact 47. In particular, the outfeed contact 47 is configured to an identical design to the infeed contact 41. This permits the number of different components to be reduced. The stationary component 45 can comprise, for example, elements of the elevator control system, the stationary component 21 of the drive unit or sensors for monitoring the elevator system. As the busbar 25 is simultaneously employed for the supply of power to stationary components 45, any additional cabling along the elevator shaft can be substantially omitted.

FIGS. 2a and 2b schematically show the operating sequences during the operation of the elevator system 11 according to the invention. FIG. 2a shows two cars 15 and 16, which can be moved along an elevator shaft 18 in a direction of travel 17. The elevator shaft 18 comprises a series of stories, of which the stories 35 and 37 are represented for exemplary purposes. The car 16 is currently stationary on story 35. The current collector 27 is thus in the first position, such that an electrical connection is present between the busbar 25 and the current collector 27. The electrical system 29 (see FIG. 1) of the car 16 is thus connected via the current collector 27 and the busbar 25 to an external power supply. Upon travel of the car 16, the current collector 27 is moved from the first position to the second position, once a speed of the car 16 exceeds a limiting speed. Reference number 15 in FIG. 2a identifies such a car, which is moving along the direction of travel 17 at a speed which exceeds the limiting speed. The current collector 27 on the car 15 is thus in the second position, in which it is disengaged from the busbar 25, such that the electrical connection between the busbar 25 and the current collector 27 is interrupted. In this state, the energy store 31 delivers the supply of electric power to electrical components 33 of the car 15.

During a normal stoppage of the car 15, the current collector 27 is conveyed from the second position back to the first position, once the speed of the car 15 undershoots the limiting speed. The connection with the external power supply is thus restored, such that the energy store 31 of the car 15 is charged once more.

FIG. 2b represents an exceptional situation, in which the car 15 has executed an emergency stop. The car 15 is thus located above story 37. In the event of an emergency stop, the current collector 27 is automatically moved to the first position, such that a supply of power to the car 15 is maintained during repair and/or evacuation.

Operation of the elevator system 11 is controlled by the control system 48. To this end, the control system 48 is configured in a signal-conductive arrangement with the cars 15 and 16, and controls the speed thereof. In the event of an undershoot of the limiting speed, the control system 48 initiates the conveyance of the current collector 27 to the first position. In the event of an overshoot of the limiting speed, the control system 48 initiates the conveyance of the current collector 27 to the second position. Likewise, in the event of an emergency stop, the control system 48 initiates the conveyance of the current collector 27 to the first position.

FIG. 3 shows a cross section through the busbar 25 and the current collector 27, wherein the current collector 25 is located in the first position. The current collector 27 comprises five collector contacts 51 and a socket 49, which holds the collector contacts 51. Laterally to the socket 49, two guides 53 are arranged, which guide a movement of the socket 49 along a compression direction 55. To this end, the guides 53 engage in corresponding recesses in the housing 57, which is connected to the car 15 (not represented in FIG. 3). On the side of the socket 49 which is averted from the busbar 25, a first pressure accumulator 59 is arranged, which compresses the current collector 27 into the first position, in which the current collector 27 is disengaged from the housing 57. In the present case, the pressure accumulator 59 comprises two helical springs 61, which engage with a bracket 63 on the housing 47, and compress the socket 49 along the compression direction 55 towards the busbar 25. Between the spiral springs 61, a pneumatic cylinder 65 is arranged. The pneumatic cylinder 65 forms part of a reset device 67. The reset device 67 further comprises a compressor 69. In the state represented, the pneumatic cylinder 65 is air-filled. For the execution of a reset, a negative pressure is applied to the pneumatic cylinder 65 by means of the compressor 69, such that the piston 71, and the socket 49 which is connected to the piston 71, are engaged, against the spring force of the helical springs 61. In this second position, the current collector 27 is retained by means of a retention device 73. The retention device 73 is configured in the form of a ventilation valve 74. For such time as the ventilation valve 74 is closed, the negative pressure in the pneumatic cylinder 65 is maintained, and the current collector remains in the engaged second position. Upon the release of the retention device 73, i.e. upon the opening of the ventilation valve 74, the pneumatic cylinder 65 is air-filled, such that the first pressure accumulator 59 compresses the current collector 27 into the first position.

The busbar 25 comprises a rail body 75 with five recesses 77, which extend in the direction of travel. In FIG. 3, the direction of travel is perpendicular to the drawing plane. The interior of each of the recesses 77 incorporates a contact region 79, to which the voltage to be transmitted is applied. In the represented first position of the current collector 27, each of the five collector contacts 51 respectively engages in a recesses 77 in the busbar, such that the collector contacts 51 make contact with the contact regions 79 in the interior of the recesses 77. The contact regions 79 are configured in the form of copper strip conductors, with which the inner side of the recesses 77 is lined. The tips of the collector contacts 51, which make contact with the contact regions 79, contain a copper-graphite mixture, which firstly shows good conductivity, and secondly is sufficiently hard to prevent excessively rapid wear of the collector contacts 51.

In the interests of the legibility of FIG. 3, only those elements in the vicinity of the right-hand collector contact are identified by reference numbers. The inscriptions numbered 51, 77, 79, 81 and 85 apply correspondingly to the remaining four collector contacts and recesses.

Along the recesses 77, the busbar 25 comprises lead-in chamfers 81. These are oriented such that for each recess 77, in cross section, an insertion funnel is constituted, which permits the secure guidance of the collector contacts 51 into the recesses 77 and onto the contact regions 79 upon insertion. In the present case, the lead-in chamfers 81 are configured as separate components. Alternatively, the lead-in chamfers 81 can be integrally formed in the rail body 75.

In addition to the mobility of the current collector 27 along a compression direction 55 between the first position and the second position, the collector contacts 51 are also moveable vis-à-vis the socket 49 along the compression direction 55. The current collector 27 comprises five second pressure accumulators 83, each of which is assigned to a collector contact 51, and which compress the associated collector contact 51 vis-à-vis the socket 49 along the compression direction 55 towards the busbar 25. The second pressure accumulators 83 are configured in the form of springs, which are arranged between the socket 49 and the collector contacts 51. By means of the pressure accumulators 83, any uneven wear of the collector contacts 51 is compensated. Uneven wear leads to the lengths of the collector contacts 51 differing from one another after a certain duration of operation. In consequence, it is possible that, in the first position, all the collector contacts 51 will no longer engage with their associated contact regions 79. Accordingly, not all the requisite electrical connections would be provided. In order to prevent this, the second pressure accumulators 83 are arranged between the socket 49 and the collector contacts 51. The pressure accumulators 83 ensure that, in such a case, the more heavily worn, and thus shorter collector contacts 51 are disengaged further from the socket 49, in order to offset the difference in length. Accordingly, in such a case, it is thus further ensured that all the collector contacts 51 make contact with their associated contact regions 79.

In addition to mobility in the compression direction 55, the collector contacts 51 are additionally pivotable vis-à-vis the socket 49 a respective swivel axis 85. This has the advantage that the collector contacts 51, even in the event of a degree of lateral offset between the busbar 25 and the current collector 27, are reliably guided, upon the insertion thereof into the recess 77, towards the contact regions 79. Upon the switchover from the second position to the first position, i.e. upon introduction of the collector contacts 51 into the recesses 77, the collector contacts 51, in the event of a lateral offset, would initially engage with the lead-in chamfers 81. As the insertion movement proceeds, the lead-in chamfers 81 effect a pivoting of the collector contacts 51 about the respective pivot axis 85, until the tips of the collector contacts 51 are able to engage in the recesses 77.

The collector contacts 51 are mutually interconnected by means of coupling elements 87, such that the collector contacts 51 are only pivotable in combination. To this end, a coupling element 87 is respectively arranged between two adjoining collector contacts 51, such that the two adjoining collector contacts 51 are mutually coupled. In the event of the swiveling of a collector contact 51, the coupling arrangement by means of the coupling element 87 leads to the connecting coupling element 87 exerting a force on the adjoining collector contact 51, such that the adjoining collector contact 51 executes a synchronous swivel motion. Consequently, the mutual interconnection of all the collector contacts 51 by means of coupling elements 87 leads to the collector contacts 51 only being pivotable in combination, in particular synchronously. Typically, the lateral offset between the busbar 25 and the current collector 27 is attributable to an error in the fitting of the busbar 25 or an error in the fitting of guide pulleys of the car 15. A further cause of a lateral offset may be uneven wear of guide pulleys of the car. After a certain duration of operation, this will also result in a lateral offset. In any event, there is consequently an overall lateral offset between the busbar 25 and the current collector 27, such that each collector contact 51 has the same lateral offset vis-à-vis its associated recess 77 in the busbar 45. Consequently, all the collector contacts 51 are required to execute the same swivel motion upon the engagement thereof in the associated recess 77. In order to compress the plurality of collector contacts 51 back to a resting position, following a pivoting thereof, the current collector 27 comprises a third pressure accumulator 89. In the present case, the third pressure accumulator 89 comprises two helical springs 91, which are arranged between the lateral outer collector contacts 51 and the guides 53 of the current collector 27. The two helical springs 91 apply a force to the plurality of coupled collector contacts 51, which counteracts the pivoting movement. A resting position is thus defined, in which the collector contacts 51 are essentially oriented in parallel with the compression direction 55. If, on the grounds of the lateral offset, pivoting of the collector contacts 51 is required during the approach movement (see above), the action of the third pressure accumulator 89 is such that the collector contacts 51, following to pull-out (i.e. in the second position of the current collector 27) are restored to their resting position.

FIG. 4 shows the current collector and the busbar from FIG. 3 wherein, in this case, the current collector is located in the second position. The various reference numbers have already been described with reference to FIG. 3.

By means of the compressor 69, a negative pressure has been applied to the pneumatic cylinder 64. As a result, the piston 71 is engaged, and the current collector 27 which is connected to the piston 71 has assumed the second position, in which it is disengaged from the busbar. The collector contacts 51 held in the socket 49 no longer engage in the recesses 77 of the busbar 25. Accordingly, there is no longer contact between the collector contacts 51 and the contact regions 79 in the interior of the recesses 77. The electrical connection between the busbar 25 and the current collector 27 is interrupted accordingly.

List of reference numbers

| | |
|---|---|
| Elevator system | 11 |
| Guide rail | 13 |
| Car | 15 |
| Car | 16 |
| Direction of travel | 17 |
| Elevator shaft | 18 |
| Drive unit | 19 |
| Linear motor | 20 |
| Stationary component | 21 |
| Mobile component | 23 |
| Busbar | 25 |
| Current collector | 27 |
| Electrical system | 29 |
| Energy store | 31 |
| Electrical components | 33 |
| Story | 35 |
| Story | 37 |
| Infeed contact | 41 |
| External power supply | 43 |
| Stationary component | 45 |
| Outfeed contact | 47 |
| Control system | 48 |
| Socket | 49 |
| Collector contact | 51 |
| Guides | 53 |
| Compression direction | 55 |
| Housing | 57 |
| Pressure accumulator | 59 |
| Helical spring | 61 |
| Bracket | 63 |
| Pneumatic cylinder | 65 |
| Reset device | 67 |
| Compressor | 69 |
| Piston | 71 |
| Retention device | 73 |
| Ventilation valve | 74 |
| Rail body | 75 |
| Recesses | 77 |
| Contact regions | 79 |
| Lead-in chamfers | 81 |
| Second pressure accumulator | 83 |
| Swivel axis | 85 |
| Coupling elements | 87 |
| Third pressure accumulator | 89 |
| Helical springs | 91 |

1.-17. (canceled)

18. An elevator system, comprising:
an elevator shaft extending along a direction of travel;
a busbar disposed in the elevator shaft and extending in the direction of travel; and
a car configured to move along the elevator shaft in the direction of travel and comprising a current collector;
wherein the current collector is configured to move between a first position and a second position along a compression direction,
wherein the current collector, in the first position, is in engagement with the busbar, such that there is an electrical connection between the busbar and the current collector, and in the second position, is disengaged from the busbar, such that the electrical connection between the busbar and the current collector is separated.

19. The elevator system of claim 18, comprising:
a drive unit configured to propel the car, wherein the drive unit is operable, regardless of whether the electrical connection is present between the busbar and the current collector.

20. The elevator system of claim 18, wherein the car comprises an energy store configured to supply power to electrical components of the car during the assumption of the second position.

21. The elevator system of claim 20, wherein the energy store is a lithium-ion accumulator.

22. The elevator system of claim 20, wherein the car comprises a first pressure accumulator configured to compress the current collector into the first position, and a retention device, which is configured to retain the current collector in the second position and is configured, upon the release of the retention device, to permit the compression of the current collector by the first pressure accumulator into the first position.

23. The elevator system as claimed in claim 22, wherein the car comprises a reset device configured to move the current collector from the first position to the second position.

24. The elevator system of claim 18, wherein the busbar comprises a plurality of recesses, which extend in the direction of travel, wherein each of the recesses comprises, in its interior, a contact region, to which the voltage which is to be transmitted is applied.

25. The elevator system of claim 24, wherein the current collector comprises a plurality of collector contacts wherein, in the first position, one collector contact respectively engages in one of the recesses, such that the collector contacts make contact with the contact regions in the interior of the recesses.

26. The elevator system of claim 25, wherein the busbar comprises lead-in chamfers, which extend along the recesses.

27. The elevator system of claim 18, wherein the current collector comprises a socket and a plurality of collector contacts, wherein each of the collector contacts is moveable relative to the socket along the compression direction, and wherein the current collector comprises a plurality of second pressure accumulators, each of which is assigned to a collector contact, and which compress the associated collector contact relative to the socket along the compression direction towards the busbar.

28. The elevator system of claim 18, wherein the current collector comprises a socket and a plurality of collector contacts, wherein each of the collector contacts is pivotable relative to the socket about a swivel axis.

29. The elevator system of claim 28, wherein the plurality of collector contacts are mutually bonded by means of coupling elements, such that the plurality of collector contacts are only pivotable in combination.

30. The elevator system of claim 29, wherein the current collector comprises a third pressure accumulator configured to compress the plurality of collector contacts back to a resting position, following pivoting thereof.

31. The elevator system of claim 18, wherein at least one stationary component is arranged in the elevator shaft, which component is supplied with power via the busbar.

32. A method for operating an elevator system, including an elevator shaft extending along a direction of travel; a busbar disposed in the elevator shaft and extending in the direction of travel; and a car configured to move along the elevator shaft in the direction of travel and comprising a current collector; wherein the current collector is configured to move between a first position and a second position along a compression direction, wherein the current collector, in the first position, is in engagement with the busbar, such that there is an electrical connection between the busbar and the current collector, and in the second position, is disengaged from the busbar, such that the electrical connection between the busbar and the current collector is separated, comprising the steps of:
moving the current collector from the first position to the second position when a speed of the car exceeds a limiting speed.

33. The method for operating an elevator system of claim 32, comprising moving the current collector from the second position to the first position when a speed of the car undershoots the limiting speed.

34. The method for operating an elevator system of claim 32, comprising conveying the current collector to the first position in the event of an emergency stop.

35. The elevator system of claim 18, comprising a control system configured to move the current collector from the first position to the second position when a speed of the car exceeds a limiting speed.

36. The elevator system of claim 18, comprising a control system configured to move the current collector from the second position to the first position when a speed of the car undershoots the limiting speed.

37. The elevator system of claim 18, comprising a control system configured to convey the current collector to the first position in the event of an emergency stop.
